(19) United States
(12) Patent Application Publication
(10) Pub. No.: US 2025/0187508 A1
(43) Pub. Date: Jun. 12, 2025

(54) SEAT ELEMENT AND VEHICLE SEAT

(71) Applicant: Adient US LLC, Plymouth, MI (US)

(72) Inventors: Stefan CARLSSON, Göteborg (SE); Johan LINDQVIST, Torslanda (SE); Salah KECHID, Illkirch (FR); Jean-Luc HAMM, Hoerdt (FR); Ahmed OUALKADI, Velbert (DE)

(21) Appl. No.: 18/976,407

(22) Filed: Dec. 11, 2024

(30) Foreign Application Priority Data
Dec. 11, 2023 (DE) 10 2023 212 452.1

(51) Int. Cl. B60N 2/58

(52) U.S. Cl. CPC B60N 2/5891; B60N 2/5816

(57) ABSTRACT

A seat element for a vehicle seat may be formed from two molded bodies arranged one on top of the other. The seat element may have a plurality of separate fastening elements for fastening at least one attachment part to the seat element. The two molded bodies may be arranged in a contact-fitting manner in relation to one another and the separate fastening elements may be mechanically and detachably fastenable or fastened to at least one of the molded bodies. A vehicle seat having the at seat element is also provided.

### FIELD

The invention relates to a seat element for a vehicle seat and to a vehicle seat comprising such a seat element.

### BACKGROUND

Seat elements, for example backrests, seat parts or the like for a vehicle seat, are known from the prior art. Seat elements of this type are usually formed from a seat carrier and a seat cushion. For fastening a seat cover to a foam part of the seat cushion, clips are generally known. Clips of this type are incorporated in the foam part by foaming. The seat cover is then fastenable to said clips.

The problem addressed by the invention is that of improving a seat element of the type mentioned at the outset, in particular in terms of the exchangeability of components, and of providing a corresponding vehicle seat.

The first problem is solved according to the invention by a seat element having the features of claim 1. The second problem is solved according to the invention by a vehicle seat having the features of claim 10.

Advantageous refinements, which may be used individually or in combination with one another, are the subject matter of the dependent claims.

The seat element according to the invention is formed from two molded bodies arranged one on top of the other, and comprises a plurality of separate fastening elements for fastening at least one attachment part to the seat element, the two molded bodies being arranged in a contact-fitting manner in relation to one another and the separate fastening elements being mechanically and detachably fastenable or fastened to at least one of the molded bodies.

The at least one attachment part may be, for example, a seat cover, a lumbar support, a seat side support or the like. The separate fastening elements may be, for example, at least one separate fastening wire and/or a plurality of separate clips.

The molded bodies may be, for example, of sheet-like or shell-like configuration. The two molded bodies may be arranged one on top of the other, in particular over their entire surface area.

Since the molded bodies and the fastening elements are formed separately and can all be mechanically and detachably joined to one another, the fastening elements, such as fastening wire and/or fastening clips, can be exchanged and replaced, as opposed to the prior art. In addition, such a seat element can be supplemented by attachment units, such as for example a lumbar support, a seat side support or the like, which are fastened to the seat element by the fastening elements. In particular, the separate fastening elements make it possible to provide or have provided the seat element with attachment units at the front and/or rear. For example, a seat cover can be or have been detachably fastened to the front of the seat element and a lumbar support can be or have been detachably fastened to the rear of the seat element by the separate fastening means.

The seat element may comprise, for example, a plurality of fastening points for fastening the at least one attachment part, such as a seat cover or the like, to the seat element, the fastening points being designed for form-fitting and/or force-fitting arrangement of the fastening elements, in particular the at least one fastening wire and/or the fastening clips.

For example, at least one first fastening point may be in the form of a through-opening through both molded bodies. At least one of the fastening elements may be arranged in such a through-opening extending through both molded bodies. For example, the fastening element may be arranged on one of the molded bodies so as to cover the through-opening toward the outside. It is also possible for another fastening element to be arranged in the region of the through-opening in such a way that it extends over the width thereof. Alternatively or additionally, the respective fastening element may be arranged on at least one of the molded bodies or on both molded bodies in a form-fitting and/or force-fitting manner and detachably joined thereto.

At least one second fastening point may be, for example, in the form of outwardly open recesses in the respective molded body. In other words, each molded body has, as at least one second fastening point, a recess that is open outwardly and thus on one side, with the bottoms of the two recesses being arranged against one another.

Alternatively or additionally, at least one third fastening point may be formed in one of the molded bodies as a through-opening and in the other molded body as an outwardly open recess. In particular, the recess in the one molded body is arranged so as to cover, in particular with its bottom, the through-opening in the other molded body.

For example, a first molded body may be in the form of a foam body. In particular, the first molded body may be formed from a polyurethane foam or another suitable foam material which, in particular, is readily air permeable, dimensionally stable and durable. In particular, the first molded body may be a foam body formed from polyurethane, at least in part from a recycled material.

A second molded body may be, for example, in the form of a flexible body having a lower strength than the first molded body. In particular, the second molded body may be formed from a woven fabric, knitted fabric, jute, gauze, felt, velour or nonwoven or a suitable, optionally thermoformed fiber-reinforced composite material, for example from a composite material or nonwoven material made of non-woven fibers, plastics fibers, based on polyethylene fibers, a polyester fiber mixture and/or a recycled fiber mixture.

A vehicle seat according to the invention comprises at least one seat element as described above, for example as a backrest or seat part.

The seat element according to the invention, for example a backrest and/or a seat part of the vehicle seat, comprises a plurality of the fastening elements described above, in particular the fastening wires and/or fastening clips, which are placed in a groove and/or in cutouts of the foam part for example for the purpose of fastening an attachment part, such as for example a seat cover and/or a lumbar support, to the foam part. The plurality of clips are designed, in particular, as identical parts.

### SUMMARY

In summary and in other words, the invention provides a seat element that allows replacement of attachment parts and/or the addition of add-on attachment parts to the seat element and manual, detachable fastening thereof to the seat element. In addition, the seat element, in particular its molded bodies, can be prefabricated and separately preformed without additional insert parts, such as the separate fastening elements. Incorporation of the fastening elements by foaming is not necessary.

### DESCRIPTION OF THE FIGURES

The invention is explained in more detail below on the basis of advantageous exemplary embodiments illustrated in the figures. However, the invention is not restricted to these exemplary embodiments. In the figures:

FIG. 1: shows, in a schematic illustration, a vehicle seat with a longitudinal adjustment device,

FIG. 2: shows a perspective exploded illustration of a seat element, formed from two molded bodies and a plurality of fastening elements for fastening at least one attachment part to the seat element,

FIG. 3: shows a rear view of the seat element according to FIG. 2 in the assembled state,

FIG. 4: shows a sectional illustration through a first fastening point for an attachment part,

FIG. 5: shows a sectional illustration through a further first fastening point for an attachment part,

FIG. 6: shows a sectional illustration through a second fastening point for an attachment part,

FIG. 7: shows a top view from the inside of a third fastening point for an attachment part,

FIG. 8: shows a top view from the outside of the third fastening point according to FIG. 7,

FIG. 9: shows a sectional illustration in the region of the third fastening point according to FIG. 7, and

FIG. 10: shows a further sectional illustration through a further region of the third fastening point according to FIG. 7 with attached attachment part.

### DETAILED DESCRIPTION

Parts which correspond to one another are denoted by the same reference signs in all the figures.

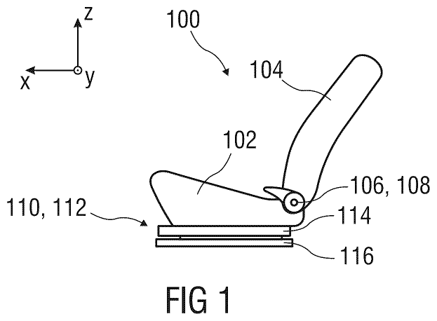

A vehicle seat 100 illustrated schematically in FIG. 1 in relation to the prior art will be described below using three spatial directions which are perpendicular to one another. In the case of a vehicle seat 100 installed in the vehicle, a longitudinal direction x extends largely horizontally and preferably parallel to a vehicle longitudinal direction, which corresponds to the normal direction of travel of the vehicle. A transverse direction y which extends perpendicularly in relation to the longitudinal direction x is likewise oriented horizontally in the vehicle and extends parallel to a vehicle transverse direction. A vertical direction z extends perpendicularly in relation to the longitudinal direction x and perpendicularly in relation to the transverse direction y. In the case of a vehicle seat 100 installed in the vehicle, the vertical direction z preferably extends parallel to a vehicle vertical axis.

The positional and directional indications used, such as for example front, rear, top and bottom, relate to a viewing direction of an occupant seated in the vehicle seat 100 in a normal sitting position, the vehicle seat 100 being installed in the vehicle, in a use position suitable for passenger transport, with an upright backrest 104, and being oriented, as is customary, in the direction of travel. The vehicle seat 100 may, however, also be installed or moved in a different orientation, for example transversely to the direction of travel. Unless described otherwise, the vehicle seat 100 is constructed mirror-symmetrically with respect to a plane running perpendicularly in relation to the transverse direction y.

The backrest 104 can be arranged pivotably on a seat part 102 of the vehicle seat 100. For this purpose, the vehicle seat 100 may optionally comprise a fitting 106, in particular an adjustment fitting, rotary fitting, latching fitting or wobble fitting.

The positional and directional indications used, such as for example radial, axial and in the circumferential direction, refer to an axis of rotation 108 of the fitting 106. Radial means perpendicular to the axis of rotation 108. Axial means in the direction of or parallel to the axis of rotation 108.

The vehicle seat 100 may optionally comprise a longitudinal adjustment device 110. The longitudinal adjustment device 110 comprises, for example, a rail arrangement 112 having a first rail element 114 and a second rail element 116. The first rail element 114 is adjustable relative to the second rail element 116 in the longitudinal direction x. The first rail element 114 is fastened to the seat part 102. The second rail element 116 is fastened to a structural element of a vehicle, for example a vehicle floor.

For improved clarity, the first rail element 114 is referred to in the following description as upper rail 114. Said upper rail 114 (also referred to as running rail or carriage) is assigned to the vehicle seat 100 and is configured to support said vehicle seat 100. The second rail element 116 is referred to below as lower rail 116. The lower rail 116 is fixed and connected, for example, to the floor of a vehicle.

The backrest 104 and the seat part 102 are each seat elements 120 of the vehicle seat 100.

The invention is described below using the example of a seat element 120 in the form of a backrest 104. The structure, and the components described below, of said seat element 120 can be applied analogously to the seat part 102.

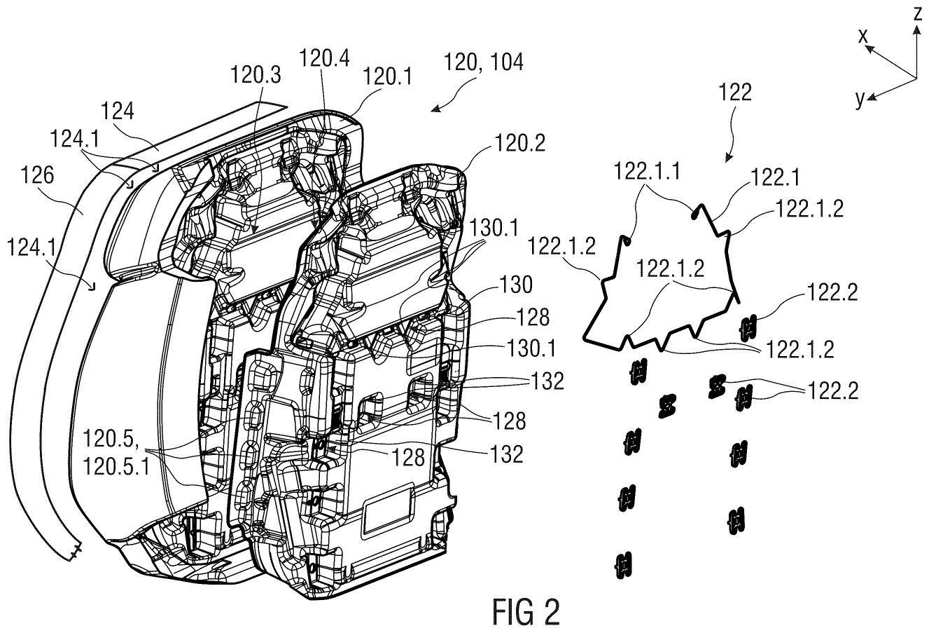

FIG. 2 shows a perspective exploded illustration of the seat element 120 in the form of a backrest 104. The seat element 120 is formed from two molded bodies 120.1 and 120.2. The seat element 120 comprises a plurality of separate fastening elements 122 for fastening at least one attachment part 124 to the seat element 120.

The attachment part 124 is, for example, a seat cover 126, which is arranged from the outside, in particular from a front side, on a first molded body 120.1 and is fastenable or fastened to the seat element 120 by the fastening elements 122. For this purpose, the attachment part 124 has counterpart fastening elements 124.1, which, in the attached state of the attachment part 124 on one of the molded bodies 120, in particular on the outside and front of a first molded body 120.1 and/or on the outside and rear of a second molded body 120.2, come into or are in a holding, in particular a detachable form-fitting and/or force-fitting, engagement with the fastening elements 122. In other words, the seat element 120 is configured by the fastening elements 122 for detachable attachment of an attachment part 124 both at the front and at the rear.

In addition, the two molded bodies 120 are configured in such a way that they are arranged in a contact-fitting manner, in particular positionally fixed in a force-fitting and/or form-fitting manner, in relation to one another. The two molded bodies 120 can also be mechanically and detachably connectable or connected to one another.

For this purpose, the molded bodies 120 may for example have contours corresponding to one another on their facing body inner sides 120.3, 120.4. For example, the second molded body 120.2 has profile contours 120.5, in particular elevations 120.5.1, studs or the like, along longitudinal sides. For this purpose, the first molded body 120.1 has complementary contours, in particular in the region of side cushions, so that the longitudinal sides of the first molded body 120.1 are positionally fixed in a force-fitting and/or form-fitting manner on the second molded body 120.2.

The separate fastening elements 122 are mechanically and detachably fastenable or fastened to at least one of the molded bodies 120, in particular on the outside, for example on a rear side of the second molded body 120.2.

For example for the arrangement, in particular pre-fixing, of the fastening elements 122, the rear side of the second molded body 120.2 may have fastening points 128, on which the fastening elements 122 can be detachably arranged, in particular pre-fixed. For example, the fastening elements 122 can be arranged on the fastening points 128 in a form-fitting and/or force-fitting and detachable manner.

The fastening points 128 may, for example, be in the form of recesses, cutouts, grooves, ribs, joints or the like.

A first fastening element 122.1 is, for example, in the form of a fastening wire, referred to below as fastening wire 122.1. The fastening wire 122.1 may, in particular, be in the form of a wire which is bent multiple times. The fastening wire 122.1 may comprise fastening eyelets 122.1.1 at its ends for additional fastening to the second molded body 120.2. The fastening wire 122.1 is, for example, substantially U-shaped. The fastening wire 122.1 may have in each case at least one bulge 122.1.2, in particular at least one V-shaped bulge, for example in at least two spatial directions, for example in the transverse direction y and in the vertical direction z. For example, the fastening wire 122.1 in the transverse direction y has four V-shaped bulges 122.1.2. The V-shaped bulges 122.1.2 may be oriented differently or identically. In the example, two V-shaped bulges 122.1.2 are oriented upward and two are oriented downward. In the longitudinal direction x, the fastening wire 122.1 is detachably insertable at the complementary fastening points 128, for example in a correspondingly configured groove 130 which is formed in the second molded body 120.2 and has, in particular, complementary V-shaped notches 130.1. The fastening wire 122.1 may be configured as a separate common wire for a plurality of fastening elements 122, e.g. for a plurality of fastening clips 122.2 at the plurality of fastening points 128. Alternatively, a plurality of separate fastening wires 122.1 may be provided.

Second fastening elements 122.2 are, for example, in the form of fastening clips, referred to below as fastening clips 122.2. The fastening clips 122.2 are designed, for example, as identical parts. The fastening clips 122.2 can be or have been arranged in the second molded body 120.2 in a positionally fixed manner at least in the transverse direction y and in the vertical direction z. In the longitudinal direction x, the second fastening clips 122.2 are detachably insertable at associated complementary fastening points 128, for example in each case in a correspondingly configured recess 132, in particular rectangular and/or U-shaped cutout, which is formed in the second molded body 120.2.

For example, the first molded body 120.1 may be in the form of a foam body. In particular, the first molded body 120.1 may be formed from a polyurethane foam or another suitable foam material which, in particular, is readily air permeable, dimensionally stable and durable. In particular, the first molded body 120.1 may be a foam body formed from polyurethane, at least in part from a recycled material.

The second molded body 120.2 may be, for example, in the form of a flexible body having a lower strength than the first molded body 120.1. In particular, the second molded body 120.2 may be formed from a woven fabric, knitted fabric, jute, gauze, felt, velour or nonwoven or a suitable, optionally thermoformed fiber-reinforced composite material, for example from a composite material or nonwoven material made of non-woven fibers, plastics fibers, based on polyethylene fibers, a polyester fiber mixture and/or a recycled fiber mixture.

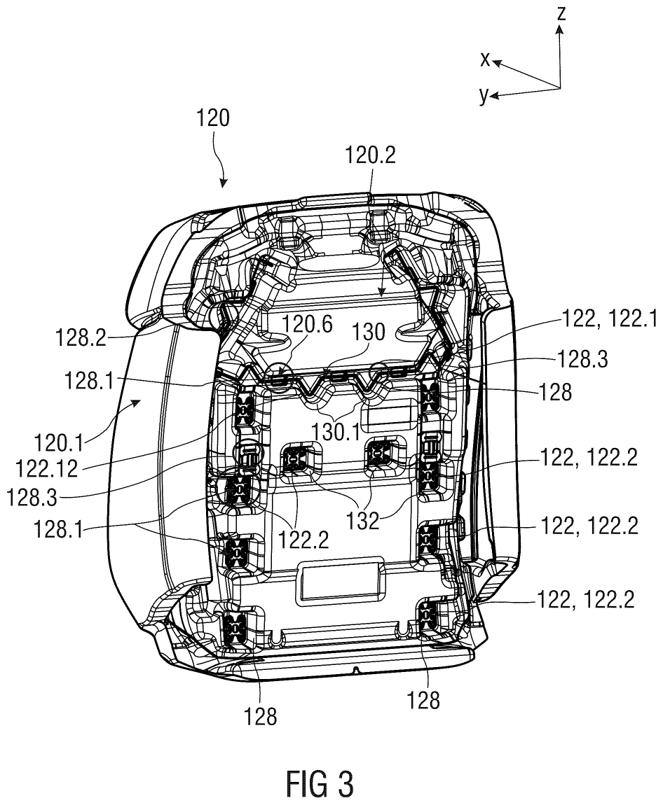

FIG. 3 shows a rear view of the seat element 120 according to FIG. 2 in the assembled state of the molded bodies 120.1, 120.2 and the fastening elements 122.

The fastening wire 122.1 is detachably inserted in the longitudinal direction x in the groove 130. The fastening wire 122.1 is arranged in the groove 130 of the second molded body 120.2 in a form-fitting and/or force-fitting manner. The V-shaped bulges 122.1.2 are inserted in the V-shaped notches 130.1. As a result, in the second molded body 120.2, the fastening wire 122.1 is arranged and held in the groove 130 in a positionally fixed manner in the transverse direction y and in the vertical direction z.

The fastening clips 122.2 are, detachably inserted in the recesses 132 in the longitudinal direction x and arranged and held in the second molded body 120.2 in a positionally fixed manner in the transverse direction y and in the vertical direction z.

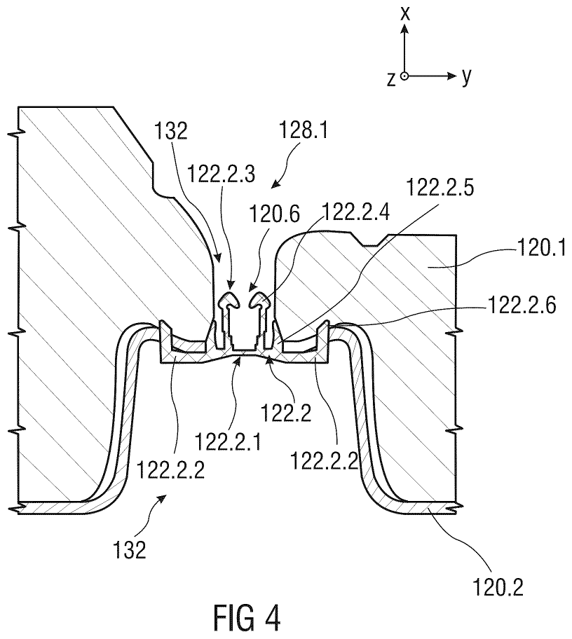

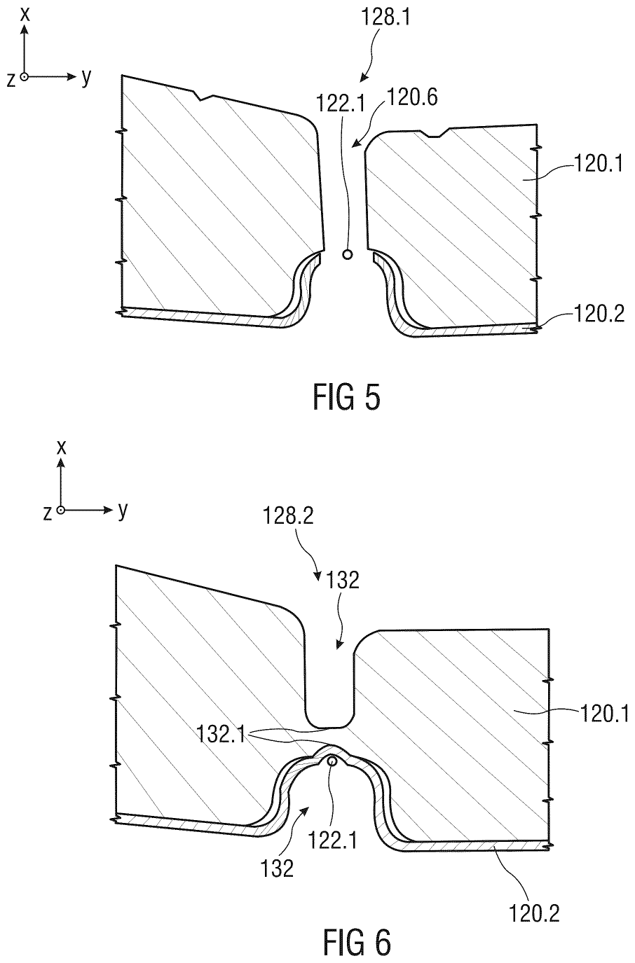

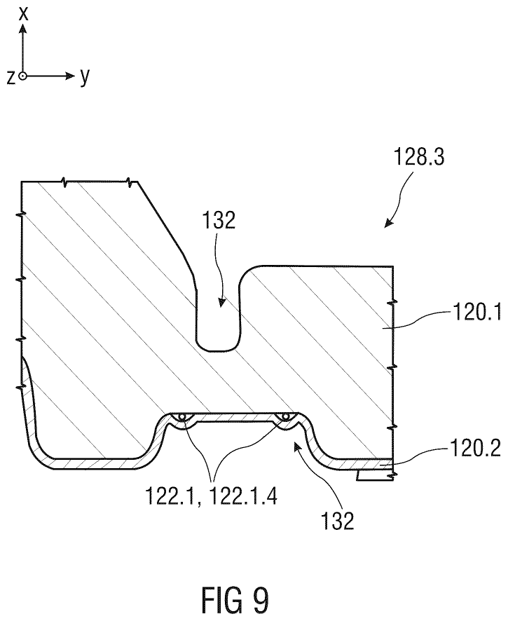

Various fastening points 128 are described below for the purpose of arranging the fastening elements 122. A first fastening point 128.1 is formed in each case in areas of fastening clips 122.2 which are inserted in the recesses 132 and/or in areas of through-openings 120.6 which are formed through both molded bodies 120.1, 120.2 and in which portions of the fastening wire 122.1 are arranged; this is illustrated in detail in FIGS. 4 and 5. A second fastening point 128.2 is illustrated in detail in FIG. 6. A third fastening point 128.3 is illustrated in detail in FIG. 9. Depending on the type and shape of the fastening elements 122, further fastening points 128 for the attachment part 124 (illustrated in FIG. 2) may be provided.

FIG. 4 shows a sectional illustration through one of the first fastening points 128.1 for the attachment part 124 (illustrated in FIG. 2). Said first fastening point 128.1 is in the form of a through-opening 120.6 through both molded bodies 120.1, 120.2.

In the example shown, one of the fastening clips 122.2 is arranged in such a through-opening 120.6 extending through both molded bodies 120.1, 120.2. The fastening clip 122.2 is in this case arranged on the second molded body 120.2 from the outside in such a way that it covers the passage opening 120.6 toward the outside.

The fastening clip 122.1 (illustrated in FIG. 2) has at least one base portion 122.2.1 with an edge portion 122.2.2, which is designed to rise in a ramp-shaped or wedge-shaped manner in certain regions. The fastening clip 122.1 comprises a central fastening portion 122.2.3 with a pair of fastening arms 122.2.4 and a pair of supporting elements 122.2.5, which support the fastening arms 122.2.4 during the fastening of the seat cover 126 (illustrated in FIG. 2). The base portion 122.2.1 is used for inserting and fixing the fastening clip 122.2 on and in the second molded body 120.2. The base portion 122.2.1 can be arranged on the second molded body 120.2 in a form-fitting and/or force-fitting manner by holding arms 122.2.6. The fastening clip 122.1 is held on the second molded body 120.2, in particular a nonwoven element, in the manner of a clamp or clip (referred to as holding clip or holding clamp). The fastening arms 122.2.4 projecting through the through-opening 120.6 are configured to receive a counterpart fastening element 124.1 (illustrated in FIG. 2) of the attachment part 124 (illustrated in FIG. 2), in particular a hook or a wire of the seat cover 126. The fastening clip 122.1, in particular the base portion 122.2.1, is optimized in terms of its surface area for a tensile force exerted by the seat cover 126 on the fastening arms 122.2.4. As a result, the fastening clip 122.1 can be in the form of a plastics part. In particular, the fastening clip 122.1 may be made of a mixture of polymeric acrylonitrile butadiene styrene (ABS) and polycarbonate (PC). The fastening clip 122.1 thereby has a particularly impact-resistant and rigid configuration and, when inserted into the second molded body 120.2, has improved grip, in particular an improved force fit, in particular frictional engagement and/or form fit.

The two fastening arms 122.2.4 and the two supporting elements 122.2.5 extend from the central fastening portion 122.2.3 vertically upward into the through-opening 120.6. The fastening arms 122.2.4 are longer than the supporting elements 122.2.5 and serve to receive and hold the counterpart fastening element 124.1.

A free end of the respective fastening arm 122.2.4 may be round. For example, the free end of the fastening arms 122.2.4 is head-shaped or ball-shaped. This facilitates mechanical insertion.

FIG. 5 shows a sectional illustration through a further first fastening point 128.1 for an attachment part 124 (illustrated in FIG. 2). The through-opening 120.6 extends through both molded bodies 120.1, 120.2. The two molded bodies 120.1, 120.2 lie against one another in a contact-fitting manner. The fastening wire 122.1 is guided on the outside in the region of the through-opening 120.6 of the second molded body 120.2. In the assembled state of the seat element 120 (illustrated in FIG. 2), a corresponding counterpart fastening element 124.1 (illustrated in FIG. 2), for example a hook, can then be introduced through the through-opening 120.6 in the first molded body 120.1 and held on the fastening wire 122.1 in a form-fitting and/or force-fitting manner. As a result of this connection, which is in particular subjected to tensile force, of counterpart fastening element 124.1 and fastening wire 122.1, the two molded bodies 120.1, 120.2 are held together in a contact-fitting manner, in particular pressed onto one another.

FIG. 6 shows a sectional illustration through one of the second fastening points 128.2 for the attachment part 124 (illustrated in FIG. 2).

Said second fastening point 128.2 may be, for example, in the form of an outwardly open recess 132 in the respective molded body 120.1, 120.2. Each molded body 120.1, 120.2 has, as a second fastening point 128.2, a recess 132 that is open outwardly and thus on one side, with the bottoms 132.1 of the two recesses 132 being arranged so as to lie against one another. The fastening wire 122.1 is guided on the outside of the second molded body 120.2 in the recess 132 at the bottom 132.1 thereof. By virtue of the fact that the fastening wire 122.1 is subjected to tension in the longitudinal direction x at the first fastening points 128.1 according to FIG. 5, the fastening wire 122.1 is also subjected to tension in part in the longitudinal direction x and in the vertical direction z at the second fastening points 128.2 and presses the two molded bodies 120.1, 120.2 onto one another in this region too.

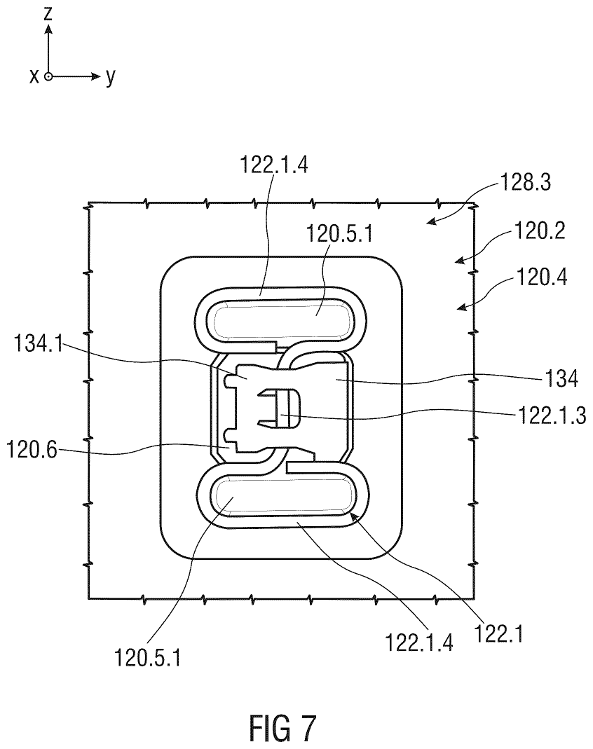

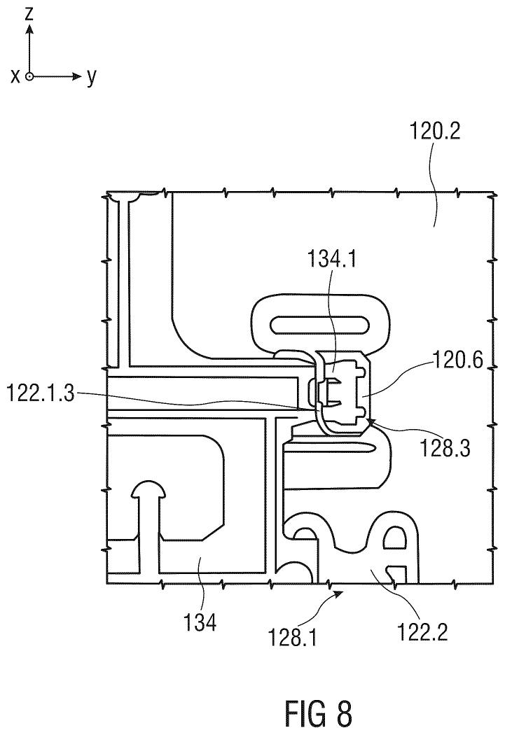

FIG. 7 shows a top view from the inside of one of the third fastening points 128.3 for a further attachment part 134, which is illustrated only in part and is, for example, a lumbar support. Said further attachment part 134 is arrangeable or detachably arranged on the rear side (also referred to as rear outer side or back) of the seat element 120 (illustrated in FIG. 2), in particular on the second molded body 120.2 from the outside thereof. FIG. 8 shows a top view from the outside of the third fastening point 128.3 according to FIG. 7.

At this third fastening point 128.3, the fastening wire 122.1 (illustrated in FIG. 2) is, for example, in the shape of an H with one, in particular central, fastening wire portion 122.1.3 and with two lateral holding wire portions 122.1.4 (illustrated in FIG. 7), in particular wire portions bent in the shape of loops or eyelets (these wire portions also being referred to as holding eyelets), adjoining said fastening wire portion.

These holding wire portions 122.1.4 can be on or can be placed on elevations 120.5.1 (illustrated in FIG. 2). For example, the elevations 120.5.1 protrude perpendicularly from the body inner side 120.4 (illustrated in FIG. 2) of the second molded body 120.2. The holding wire portions 122.1.4 can be bent multiple times and placed around an outer contour of the elevation 120.5.1 and thus arranged on the second molded body 120.2 in a positionally fixed manner in the vertical direction z and in the transverse direction y.

A counterpart fastening element 134.1, in the form of a hook, of the further attachment part 134 (in the assembled state, as illustrated) is, for example, in a holding engagement on the fastening wire portion 122.1.3.

Below the third fastening point 128.3, it is possible to provide a first fastening point 128.1 for fastening the seat cover 126 (illustrated in FIG. 2) on the remote side of the seat element 120 (illustrated in FIG. 2).

The at least one third fastening point 128.3 is, at least in the second molded body 120.2, in the form of a through-opening 120.6. At said third fastening point 128.3, in certain regions a passage opening 120.6 (as shown in FIG. 5) for the fastening wire 122.1 and in certain regions an outwardly open recess 132 (as shown in FIG. 9) for receiving and positionally fixing the lateral holding wire portions 122.1.4 can be formed in the first molded body 120.1 (illustrated in FIG. 2).

FIG. 9 shows a sectional illustration in the region of the third fastening point 128.3 according to FIG. 7.

The lateral holding wire portions 122.1.4 are arranged, for example, between the two molded bodies 120.1 and 120.2. As a consequence of the dimensionally stable configuration of the first molded body 120.1 and the flexible configuration of the second molded body 120.2, a portion of the second molded body 120.2 bears in a contact-fitting manner against the holding wire portions 122.1.4.

As a result of the recesses 132 formed on both sides in the first molded body 120.1, the second molded body 120.2 can be arranged on the first molded body 120.1 in a positionally fixed manner in at least one spatial direction, in particular in the transverse direction y.

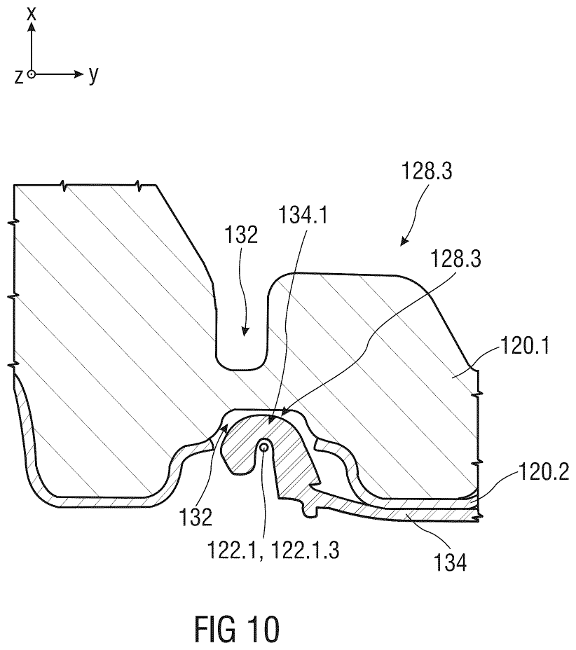

FIG. 10 shows a further sectional illustration through a further region of the third fastening point 128.3 according to FIG. 7 with attached further attachment part 134.

The counterpart fastening element 134.1 is in engagement with the fastening wire portion 122.1.3 of the fastening wire 122.1. Only the second molded body 120.2 has a through-opening 120.6 (illustrated in FIG. 3). The first molded body 120.1 has recesses 132 for forming the third fastening point 128.3 and for positionally fixing both the second molded body 120.2 on the first molded body 120.1 and the counterpart fastening element 134.1.

### LIST OF REFERENCE SIGNS

100 Vehicle seat
102 Seat part
104 Backrest
106 Fitting
108 Axis of rotation
110 Longitudinal adjustment device
112 Rail arrangement
114 First rail element (upper rail)
116 Second rail element (lower rail)
120 Seat element
120.1 First molded body
120.2 Second molded body
120.3 Body inner side of the first molded body
120.4 Body inner side of the second molded body
120.5 Profile contour
120.5.1 Elevation
120.6 Through-opening
122 Fastening element
122.1 Fastening wire
122.1.1 Fastening eyelet
122.1.2 Bulge
122.1.3 Fastening wire portion
122.1.4 Holding wire portion
122.2 Fastening clip
122.2.1 Base portion
122.2.2 Edge portion
122.2.3 Fastening portion
122.2.4 Fastening arm
122.2.5 Supporting element
122.2.6 Holding arm
124 Attachment part
124.1 Counterpart fastening element
126 Seat cover
128 Fastening point
130 Groove
130.1 Notch
132 Recess
134 Further attachment part
134.1 Counterpart fastening element
X Longitudinal direction
y Transverse direction
Z Vertical direction

What is claimed is:

1. A seat element for a vehicle seat,
the seat element being formed from two molded bodies arranged one on top of the other, and comprising a plurality of separate fastening elements for fastening at least one attachment part to the seat element,
the two molded bodies being arranged in a contact-fitting manner in relation to one another and
the separate fastening elements being mechanically and detachably fastenable or fastened to at least one of the molded bodies.

2. The seat element as claimed in claim 1, which comprises a plurality of fastening points for fastening the attachment part to the seat element,
the fastening points being designed for form-fitting and/or force-fitting arrangement of the fastening elements.

3. The seat element according to claim 1, wherein the fastening element is a separate fastening wire.

4. The seat element according to claim 1, wherein the fastening element is a separate fastening clip.

5. The seat element according to claim 1, wherein a plurality of fastening elements are coupled by a single separate common fastening wire to connect the two molded bodies to each other.

6. The seat element according to claim 4, wherein a plurality of fastening clips are coupled by a single separate common fastening wire to connect the two molded bodies to each other.

7. The seat element according to claim 1, a first fastening point being in the form of a through-opening through both molded bodies.

8. The seat element according to claim 1, a second fastening point being in the form of outwardly open recesses in the respective molded body.

9. The seat element according to claim 1, a third fastening point being formed in one of the molded bodies as a through-opening and in the other molded body as an outwardly open recess.

10. The seat element according to claim 1, a first molded body being in the form of a foam body.

11. The seat element according to claim 1, a second molded body being in the form of a flexible body having a lower strength than the first molded body.

12. The seat element according to claim 1, one of the molded bodies being formed from a woven fabric, knitted fabric, jute, gauze, felt, velour or nonwoven or a thermoformed fiber-reinforced composite material.

13. The seat element according to claim 1, one of the molded bodies being a foam body formed from polyurethane, at least in part from a recycled material.

14. The seat element according to claim 1, wherein a first attachment part is attached to a first side of the seat element and fixed by the fastening elements.

15. The seat element according to claim 14, wherein the first side of the seat element is an upper side or a front side of the seat element.

16. The seat element according to claim 1, wherein a second attachment part is attached to a first side of the seat element and fixed by the fastening elements.

17. The seat element according to claim 16, wherein the second side of the seat element is a lower side or a rear side of the seat element.

18. The seat element according to claim 16, wherein the first side of the seat element is opposite to the second side of the seat element.

19. A vehicle seat having at least one seat element as claimed in claim 1.
